(19) United States
(12) Patent Application Publication
(10) Pub. No.: US 2020/0115521 A1
(43) Pub. Date: Apr. 16, 2020

(54) FILM WITH LOW HEAT CONDUCTIVITY, REDUCED DENSITY AND LOW SOLAR ABSORPTION

(71) Applicant: CONSTRUCTION RESEARCH & TECHNOLOGY GMBH, Berlin (DE)

(72) Inventor: GERD HUGO, Schondorf (DE)

(21) Appl. No.: 16/585,656

(22) Filed: Sep. 27, 2019

Related U.S. Application Data
(63) Continuation of application No. 15/421,901, filed on Feb. 1, 2017, now abandoned.
Application No. 15/421,901 is a continuation of application No. 11/791,825, filed on May 30, 2007, now abandoned.

(30) Foreign Application Priority Data
Dec. 3, 2004 (DE) 10 2004 058 425.7

(51) Int. Cl. C08K 3/013; D06P 1/52; C14C 11/00; C08K 7/24; C08K 3/22; C04B 41/48; C09D 5/33; C08K 5/00; C04B 41/63; C04B 41/00; C09D 7/40; C09D 133/08; C09D 133/10; C09D 133/16; C09D 135/06; C09D 139/06; C09D 131/04; D06P 1/44; C04B 28/02; C04B 28/14

(52) U.S. Cl. CPC C08K 3/013; C04B 2111/00612; C14C 11/003; C08K 7/24; C08K 3/22; C04B 41/48; C09D 5/004; C08K 5/0041; C04B 41/63; C04B 41/009; C09D 7/70; C09D 133/08; C09D 133/10; C09D 133/16; C09D 135/06; C09D 139/06; C09D 131/04; C04B 41/483; D06P 1/44; C04B 28/02; C14C 11/00; C04B 28/14; C08K 2003/2268; C08K 2003/2241; D06P 1/52

(57) ABSTRACT

The invention relates to a dark, flat element, preferably a plastic, lacquer coating or fiber material, having reduced density, low heat conductivity and low solar absorption. The flat element has a relatively high reflection infrared range of the electromagnetic spectrum reduce heating by sunlight in the near infrared dark tinting in the visible range. Low density conductivity are obtained inter alia by inserting in the near in order to area despite and low heat light filling materials into the flat element. Said flat element can be used in places where surfaces are dark tinted for aesthetic or technical reasons but should not heat up in sunlight and should give off little heat when touched by hand or by other parts of the body. Other areas of application include surfaces which should have a heat insulating effect in addition to the above-mentioned characteristics.

The present invention relates to a dark flat element, preferably made of plastic, a lacquer coating or a fiber material, with reduced density, low heat conductivity and low solar absorption.

Surfaces that are tinted or coated dark for aesthetic or other technical reasons and are exposed to sunlight have the generally unpleasant property of more or less heating up under the influence of solar radiation, according to color intensity.

Solar heating of dark surfaces is perceived as extremely unpleasant, particularly in smaller spaces, like in a vehicle, be it a passenger car, truck, bus or also the interior of a railway car. The dark surfaces are heated up more or less strongly according to degree of solar absorption and release this absorbed heat as heat radiation and by air convection into the interior. Thus, the steering wheels of passenger cars, standing for a few hours in the sun in the summer, can heat up to above 80° C.

Solar energy, once absorbed by dark surfaces in a vehicle, cannot directly leave the vehicle, since the windows of the vehicle are not transparent in the range of heat radiation in the long-wave infrared at 5 to 50 μm, and normally are also closed in a parked vehicle, so that no air exchange can occur either.

Dark tinting of surfaces in a vehicle is partly caused by technical reasons, since a light front compartment would be reflected in the windshield and therefore adversely affect vision from the vehicle.

Seat surfaces are preferably tinted dark for aesthetic and practical reasons, since light surfaces very quickly become dirty.

The relatively high heat storage capacity of these dark surfaces also contributes to the shortcoming for heating of the interior of the vehicle. The higher the heat capacity and heat conductivity into the material, the more solar energy can be stored in the materials. Heat release then occurs slowly by heat radiation and convection through the air. While the heated air can be exchanged relatively quickly by opening the windows during driving, the occupants of a vehicle, however, are exposed to radiation heat, until the heat storage, for example, the front compartment or the dashboard support, is “empty”, i.e., cooled down. This heat radiation can only be compensated during operation of the vehicle via the air conditioner. A drawback is that even modern air conditioners during operation increase the fuel consumption of a vehicle by about 10%. In addition to the high heat absorption, these surfaces also contribute to fuel consumption of a vehicle because of their weight, for which reason a lower weight, for example, by reduced bulk density, is desired.

Another area of application for dark surfaces is in plastic sheathing of houses and plastic window frames, as are common especially in the USA. Although tinting of this sheathing and these window frames is carried out not in extremely dark, but rather average tints, they exhibit a surprisingly high solar absorption capacity. They therefore strongly heat up under the influence of solar radiation, which leads to rapid material fatigue and aging. Their heat conductivity is too high for them to make a positive contribution to thermal insulation of the building.

Another area of application is roofing, which consists, for example, in the USA, usually of bitumen shingles, or also concrete shingles. These roof shingles are mostly kept in darker green, gray and red tints and their solar absorption is generally greater than 80%. Here again, the high solar absorption leads to rapid material fatigue, especially in bitumen shingles, for which reason, during extreme weather situations, for example, hail, they can no longer offer any protection for the house. Moreover, the heat resistance of these roof coverings is too low for them to contribute beneficially to thermal insulation of the roof.

A heat-reflecting coating is described in U.S. Pat. No. 4,272,291 (Shtern, et al.), which is supposed to protect against weather effects and reduce heating of metal surfaces, especially on fuel tanks. This is supposed to be achieved by the interaction of inorganic metal compounds in the binder-containing coating formulation. However, a drawback is that this coating has no heat-insulating effect.

A coating with heat-insulating effect is known from Japanese Unexamined Patent Application JP 11-323197 (Application Number JP 10-130742), which also has good emission properties and good long-wave properties relative to heat radiation, so that it has insulating properties relative to large heat effects. The coating has transparent or light-permeable vacuum spheres made of ceramic material and auxiliary means to maintain the structure that are supposed to guarantee tight packing of the ceramic bubbles and their flat arrangement after application of the coating as a film. Acrylamide derivatives, polyethylene waxes, bentonite and silica particles are supposed to be suitable as such auxiliary means. However, cellulose, acrylic acid polymers and polyvinyl alcohol are also suitable. This coating consists of 30 to 60% of the mentioned hollow bubbles.

A coating that is supposed to protect against heat effects is also known from Japanese Unexamined Patent Application JP 2000-129172 (Application Number 10-305968). Specific pigments are combined with a support material having excellent weather resistance. A heat-protective coating with pronounced reflection properties in the near infrared range is supposed to be produced on this account, which even heats up only relatively little, when the coating overall is made black or in a dark color. The pigment employed for this purpose absorbs light in the visible range and reflects light in the near infrared range. An acrylic resin is used as support material. In this case as well, the described coating does not have a heat-insulating effect. Indications of the density and heat conductivity of the described coating cannot be deduced from this document either.

A coating material with low emission and high reflection capacity in the wavelength range of heat radiation is known from DE-A1 44 18 214. This coating contains a binder with high transparency in the range of heat radiation, and especially in the range of wavelengths from 3 to 50 μm, as well as particles that have high transparency in this wavelength range, and whose refractive index in the wavelength range of heat radiation is different from the refractive index of the binder.

A coating with reflecting properties in two wavelength ranges and absorbing properties in a third wavelength range is protected by EP 0 804 513 B1. This coating essentially contains a binder with a transparency greater than 40% and a refractive index n<2.0 in a wavelength range from 0.38 to 0.75 μm (first wavelength range) and in a wavelength range from 5 to 100 μm (third wavelength range). Lamellar particles with defined thickness and area, as well as a reflection capacity R in the third wavelength range >40%, are contained in this binder. This binder also contains second particles that partially cover the first lamellar particles and, in the first and third wavelength range, have a transparency >40% and, in a wavelength range from 0.8 to 2.5 μm (second wavelength range), an absorption >20%, and also have a defined refractive index in the first wavelength range. This coating can be used as a wall, roof or façade paint for buildings or tanks.

A coating material suitable for energy savings in houses and buildings, and capable of absorbing solar energy in the interior and exterior area without emitting it again directly in the long-wave region of thermal infrared is known from EP 0 942 954 B1. This coating material consists of a binder with high transparency, first platelet-like particles that reflect, especially in the wavelength range of thermal infrared, and first spherical particles that backscatter in the wavelength range of thermal infrared and have a defined transmission in this wavelength range, and/or second spherical particles that have a cavity in the dry state and a defined transmission in the range of thermal infrared and backscatter and/or reflect in the wavelength range of thermal infrared. This coating material also contains second particles that reflect and/or backscatter in the wavelength range of visible light and have a defined transmission in the wavelength range of thermal infrared and are present as monocrystals. Additional components include polymer pigments that have a defined transmission in the thermal infrared and have a cavity in the dry state, third spherical particles that are electrically conducting and have limited absorption in the range of thermal infrared, as well as other known additives that are ordinarily used in coatings.

European Patent 1 137 722 B1 concerns a spectrally selective coating that absorbs solar energy in the infrared range less strongly and has low thermal emission. This coating is particularly suited for the front compartment surface of vehicles and is characterized by three components, in which a binder with defined transmission in the wavelength range of near infrared, and an also defined transmission in the wavelength range of thermal infrared, is involved. The second component represents a first pigment, which absorbs in the wavelength range of visible light, has a backscatter of at least 40% in the near infrared and has absorption of 60% or less in the wavelength range of thermal infrared. The third component finally represents a second pigment, which has a backscatter and/or reflection of ≥40% in the wavelength range of thermal infrared.

A coating with low solar absorption is known from US 2004/0068046 A1. This coating essentially consists of four components, in which a binder, first pigments, second pigments and/or third pigments, as well as a filler, are involved. The binder component must have a transparency of >60% in the wavelength range of ultraviolet and visible light and in the near infrared range, and also a transparency <70% in the thermal infrared range. The first pigments are characterized by a transparency >70% in the wavelength range of 300 to 2,500 nm, the particle size being chosen, so that the backscatter amounts to >70% in the near infrared wavelength range. The second pigments must absorb spectrally-selective, in the visible wavelength range, have a transparency in the near infrared range >50% and an absorption >40% in the thermal infrared range. The third pigments must also absorb in the spectrally-selective range of visible light and/or absorb 50% in the wavelength range of visible light, as well as reflect in the near infrared range. The employed fillers are supposed to reduce the refractive index of the binder matrix, the max consisting of hollow microspheres that are filled with gas or air and have a defined particle size. Such coatings are particularly suitable for surfaces that are colored dark for technical or aesthetic reasons and, at the same time, are exposed to sunlight, so that they heat up extremely.

A flat construction element made of metal, whose outer surface is coated, so that it reflects sunlight in the range of near infrared, and whose inner surface has a low emission for heat radiation, is known from the German Patent DE 102 04 829 C1. This flat construction element is provided on its first outer surface with a first coating that protects the metal from corrosion and reflects sunlight in the wavelength range from 320 to 1,200 nm, on average, by 60%. Its first outer surface is provided with a second coating that has a reflection <60% in the wavelength range of visible light and a reflection >60% in the wavelength range of near infrared. The second inner surface of the construction element is provided with a first coating that protects the metal from corrosion and the second inner surface with a second coating, which is low-emitting in the wavelength range of thermal infrared and has an emission of <0.75°.

The task of the present invention is to configure ordinary, especially darker, surfaces in the mentioned areas of application, so that they absorb less sunlight and heat up less.

This is solved according to the invention by a dark, flat element with low heat conductivity, reduced density and low solar absorption, characterized in that

a) it has at least one combination of a support material with components incorporated in it, in which b) the combination a) has a heat conductivity of less than 0.4 (W/m·K) and

c) a bulk density below 1.4 g/cm³, d) that the element has an average reflection in the wavelength range of visible light from 400 to 700 nm that is less than 50%, and e) that the element has an average reflection in the wavelength range of near infrared from 700 to 1,000 nm that is greater than 50%.

Advantageous modifications of the invention are apparent from the dependent claims.

In numerous applications of the element according to the invention it has surprisingly turned out that a combination of a material with simultaneously low heat conductivity and density with the highest possible reflection on the material surface in the invisible, near infrared range offers several synergistic effects. Thus, a dark object, for example, a passenger car steering wheel, becomes significantly less hot when the surface of this object is reflecting in the near infrared: for example, if a car stands long enough in the sun, the steering wheel heats up convectively to the level of the inside air. Because of simultaneously reduced heat conductivity and density of the steering wheel, however, it does not heat up as quickly and can be grasped without problems, even though high temperatures prevail in the surrounding space.

Surprising synergistic effects are also obtained in typical applications in the area of building technology by the combination according to the invention of high reflection of a surface in the near infrared range with low heat conductivity and density of the overall arrangement. Thus, a wall panel made of PVC with the features of the element according to the invention becomes less hot than an ordinary PVC wall panel; on the other hand, because of the lower heat conductivity and density of the panel, less of the solar energy that is absorbed anyway is introduced to the building by heat conduction. In addition, the lower surface temperature and slowed temperature change reduce heat-related material fatigue of the overall arrangement.

A support material, involving a plastic, a lacquer coating, a fiber material, a hydraulic binder and/or a composite has proven to be particularly favorable. With reference to the plastic as support, this should be chosen from the series of polyamides, polyacetates, polyesters, polycarbonates, polyolefins, like polyethylene, polypropylene and polyisopropylene, from the styrene polymers, like acrylonitrile/butadiene/styrene ABS, polystyrene, styrene/butadiene, styrene/acrylonitrile, acrylonitrile/styrene/acrylic esters, from the sulfur polymers, like polysulfone, polyether-sulfone, polyphenylsulfone, from the fluoroplastics, like PTFE, (polytetrafluoroethylene) and PVDF (polyvinylidene fluoride), from the polyimides, polymethylmethacrylates PMMA, like polyvinyl chloride, from the silicones, like silicone rubber, epoxy resins, from polymer blends, like polyphenylene oxide, polycarbonate-ABS, and from the melamine-phenolic resins and polyurethanes and their appropriate mixtures. A support material that can be both a reactively crosslinking plastic and a thermoplastic has proven to be particularly advantageous.

If a lacquer coating is to be contained as support material as component a) in the element according to the invention, it should be formed from a binder, chosen from the series of aqueous binders, preferably water-soluble binders from alkyds, polyesters, polyacrylates, epoxides and epoxide esters, aqueous dispersions and emulsions, and preferably dispersions and emulsions based on acrylates, styrene-acrylates, ethylene-acrylic acid copolymers, methacrylates, vinylpyrrolidone-vinyl acetate copolymers, polyvinylpyrrolidone, polyisopropyl acrylate, polyurethane, silicone and polyvinyl acetates, wax dispersions, preferably based on polyethylene, polypropylene, Teflon®, synthetic waxes, fluorinated polymers, fluorinated acrylic copolymers in aqueous solution, fluorosilicones, so that it is chosen from terminal and lateral and/or intrachenar fluorine-modified polyurethane resins, preferably polyurethane dispersions and polyurethane-polymer hybrid dispersions and their mixtures.

However, the lacquer coating can also be formed from a binder, chosen from the series of solvent-containing binders, preferably acrylates, styrene-acrylates, polyvinyls, polyvinyl chloride, polystyrenes and styrene copolymers, alkyd resins, saturated and unsaturated polyesters, hydroxide-functional polyesters, melamine-formaldehyde resins, polyisocyanate resins, polyurethanes, epoxy resins, fluoropolymers and silicones, chlorosulfinated polyethylene, fluorinated polymers, fluorinated acrylic copolymer, fluorosilicones, plastisols, PVDF (polyvinylidene fluoride), so that it is chosen from terminal and lateral and/or intrachenar fluorine-modified polyurethane resins, preferably polyurethane dispersions and polyurethane-polymer hybrid dispersions and their mixtures. Fluorine-modified polymers that contain polymer structural elements based on perfluoroalkyl(ene) and/or polyhexafluoropropene oxide groups terminally and/or laterally and/or in the main chain, are characterized with the expression “terminal and lateral and/or intrachenar fluorine-modified polyurethane resins”.

With respect to support material, another variant of the invention consists of using leather from animal skins in the element as fiber material.

Another advantageous modification of the idea of the invention is given by the fact that the hydraulic binder is a mixture based on cement, calcium sulfate or anhydrite, and preferably is concrete, mortar or gypsum.

With respect to the composite, this should contain synthetic and/or natural fibers, preferably synthetic fibers from plastics and/or ceramics, especially glass and/or carbon and/or natural fibers from wool, cotton, sisal, hemp and cellulose.

Finally, the components incorporated in the support material can be chosen from the following groups:

a) inorganic and/or organic light fillers, which preferably reduce the density and heat conductivity of the support material, b) gases, like air, nitrogen, carbon dioxide, noble gases, which form cavities in the support material and reduce the density and heat conductivity of the support material and c) dyes, which reflect with spectral selectivity in the wavelength range of visible light from 400 to 700 nm and have an average transparency of greater 50% in the wavelength range of the near infrared from 700 to 1000 nm, and/or d) first pigments, which reflect with spectral selectivity in the wavelength range of visible light from 400 to 700 nm and have an average transparency of greater than 50% in the wavelength range of near infrared from 700 to 1,000 nm, and/or e) second pigments, which reflect with spectral selectivity in the wavelength range of visible light from 400 to 700 nm and have an average reflection of greater than 50% in the wavelength range of the near infrared from 700 to 1,000 nm, f) inorganic and/or organic nanomaterials, which can be surface-treated or surface-coated.

The term “nanomaterials” or also “nanoparticles” is understood to mean, in general, particles with a roughly spherical geometry that are smaller than 100 nm in all dimensions, no lower limit being defined. Nanomaterials, which ordinarily consist of nanoparticles or contain mostly nanoparticles, occupy a place in the transitional range between atomic and continuous macroscopic structures with respect to their size. Typical examples of inorganic nanoparticles are nanoscale silicon dioxide, titanium dioxide, zinc oxide, silica sols, water glass, metal colloids and pigments, which also can be functionalized. Dispersions, and especially fine particle dispersions, polyurethane dispersions and core-shell dispersions, but also pigments, dendrimers, and optionally functionalized hyperbranched polymers, are typical representatives of inorganic nanomaterials. In the present case, fillers from the Aerosil Series from Degussa AG have proven to be particularly suitable as inorganic nanomaterial. However, all fillers that do not absorb in the visible and near infrared range, and whose particle size lies below 100 nm, are generally suitable.

The choice of components incorporated in a support material, and especially the aforementioned components c) to e), ordinarily occurs by means of technical methods. Reflection of surfaces, but also of pigments and fillers, are usually measured with a spectrometer, like the PC 2000 PC-plug-in spectrometer from The Avantes company, with a spectral sensitivity from 320 to 1,100 nm, so that ranges from UV (above the visible range) into the near infrared range are covered. Hemispherical backscatter of surfaces is measured with an Ulbricht sphere connected to the spectrometer, and the reflection determined. Here, a barium sulfate plate serves as reference, which represents almost 100% reflection. For measurement of pigments and fillers in powder form, these are filled into a polyethylene bag, which is transparent in the mentioned wavelength range. In order to be able to distinguish between reflection of a layer and transmission of this layer, the layer is measured once on an absorbing, i.e., black background and on a 100% reflecting, i.e., white background.

In particular, the light fillers should be those whose density lies below 0.5 g/cm³.

An element is considered particularly advantageous, whose component a) includes a support material containing, as incorporated components, hollow microspheres from a ceramic material, glass or plastic, in which the density of the hollow microspheres made of glass or other surrounding material lies below 0.4 g/cm³ and the density of the hollow microspheres consisting of plastic should lie below 0.2 g/cm³.

An advantageous modification of the idea of the invention is seen in the fact that the light fillers are plastic particles that only form hollow microspheres with a density below 0.2 g/cm³, when the support material is heated to temperatures from 80 to 160° C.

In the present invention, dyes are considered preferred, which are water-soluble dyes, chosen from acid dyes, direct dyes, basic dyes, development dyes, sulfur dyes and aniline dyes, or from dyes of the group of dyes that are dissolved with solvents or zapon dyes.

The first pigments should advantageously come from the series of organic pigments, preferably from the azo pigments, for example, monoazo, disazo, α-naphthol, naphthol-AS, laked azo, benzimidazolone, disazo condensation, metal complex, isoindolinone and isoindoline pigments, from the polycyclic pigments, and preferably phthalocyanine, quinacridone, perylene and perinone, thioindigo, anthraquinone, anthrapyrimidine, flavanthrone, pyranthrone, indanthrone, anthanthrone, dioxazine, triarylcarbonium, quinophthalone, diketo-pyrrolo-pyrrole pigments.

With respect to the second pigments, the present invention considers a variant, in which inorganic pigments are involved, chosen from a series of metal oxides and hydroxides, from cadmium, bismuth, chromium, ultramarine pigments, coated, platelet-like mica pigments, and especially rutile and spinel mixed phase pigments.

Finally, the invention also proposes that additional particles can be introduced to the support material, which have reflection greater than 70% in the wavelength range of 400 to 1,000 nm. These additional particles should be chosen especially from the group of inorganic pigments, the group of metal oxides, metal sulfates, metal sulfides, metal fluorides, metal silicates, metal carbonates, as well as their mixtures.

The additional particles can also be chosen from the group of degradable materials; however, calcium carbonate, magnesium carbonate, talc, zirconium silicate, zirconium oxide, aluminum oxide, natural barium sulfate and their mixtures can also be involved.

An essential feature of the flat element is seen in the heat conductivity of the combination of support material with the components incorporated in it. In this respect, it is considered preferable, if the heat conductivity of the entire element is less than 0.3 (W/m·K), and especially less than 0.2 (W/m·K).

It can also be advantageous, if the bulk density of the entire element lies below 1.2 g/cm³, and especially below 1.0 g/cm³.

Another feature essential to the invention is seen in the average reflection of the element in the wavelength range of visible light from 400 to 700 nm. This should especially be <40%.

An advantageous modification of the claimed element is given by the fact that it has an average reflection greater than 60% in the wavelength range of the near infrared from 700 to 1,000 nm.

It is also considered by the invention, if the light fillers increase reflection of the element in the near infrared range from 700 to 1,000 nm by up to 10%.

According to the present invention, the combination a) must have the features b) (heat conductivity) and c) (bulk density). This combination of support material and incorporated components, however, can also have features d) and/or e) of the element, in addition to the features heat conductivity and bulk density.

The element itself can be composed according to the invention also of at least two layers, in which case at least one layer should consist of combination a).

Combination a) can also be combined with a layer of support material containing no incorporated components, which is also considered by the present invention.

It is also considered particularly advantageous, if identical or different variants of the element can be combined with each other in at least two layers. The element can also be provided with an additional lacquer coating, which is preferably a transparent form.

With respect to the element, this can be combined with a supporting substrate in the form of an arrangement, device or layer, in which it can then represent, overall, a supporting arrangement.

Overall, it is established that the claimed dark, flat element necessarily consists of a combination of a support material with components incorporated in it, this combination having a defined heat conductivity and special bulk density. This element can therefore consist exclusively of this combination a), but need not, but can also contain additional components. The element itself can therefore be a specially treated leather, a plastic mold, for example, for vehicle interior fittings, or also a cladding panel or shingle. Based on the different variants, the claimed element can also consist of a base or support structure, on which the combination a) is fastened or applied. Overall, however, the flat, overall element must be dark, which is stipulated by the essential feature d), i.e., the low average reflection in the wavelength range of visible light from 400 to 700 nm of <50%. From the wording of Claim 1, which characterizes an actual object of the invention, the variety of possibilities of the present invention is apparent, since it is not restricted only to claddings or coatings, but includes also combinations, consisting of a base or support structure or primer layers and combinations situated on them of a support material and the components incorporated in it.

The following examples explain the advantages of the invention just described.

### EXAMPLES

Figures

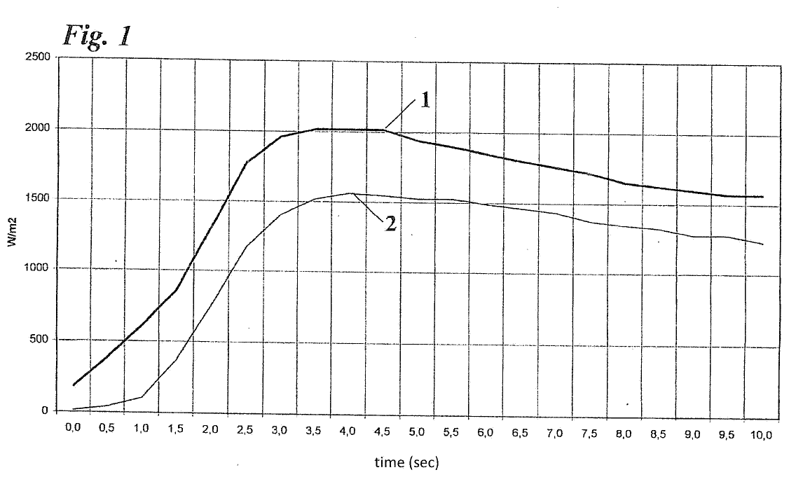

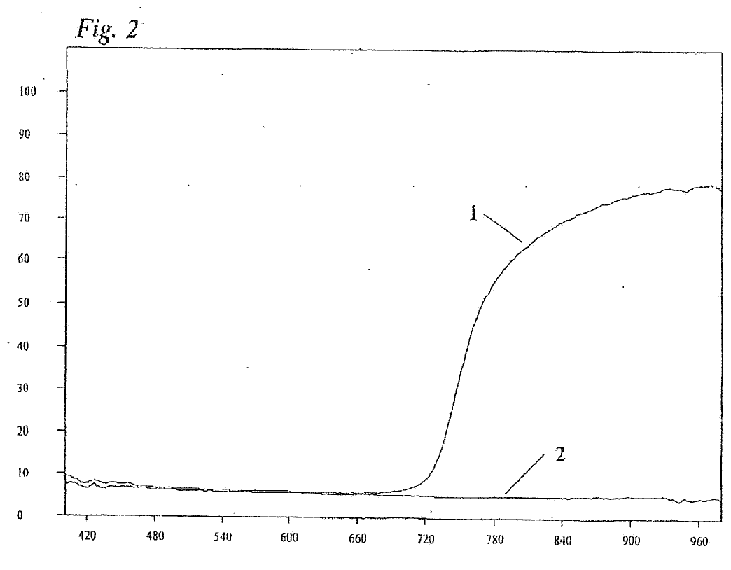

Heat flow through a material sample described in the examples is shown in FIGS. 1, 3 and 4. A universal heat flux sensor F-035-2, measuring 25×25 mm, from the Wuntronic company, Munich, is used in these measurements, which delivers a voltage equivalent to heat flux. FIGS. 2 and 5 to 11 show as measurement results the spectral reflection of the samples for the corresponding examples in the wavelength range 400 to 980 nm. A PC-plug-in spectrometer PC 2000, from The Avantes company, with a spectral sensitivity from 320 to 1,100 nm, serves as measurement instrument, with an Ulbricht sphere connected to it to measure hemispherical backscatter of surfaces.

### Example 1

Tinting and Coating of Leather for Auto Seats:

A piece of leather is tinted black with the dye Sella Cool Black 10286 from TFL Ledertechnik, Basel.

The following black coating is prepared:

15.00 g Roda Cool Black pigment preparation from TFL Ledertechnik, Basel

60.00 g Roda Car B32 from TFL Ledertechnik, Basel

10.00 g Roda Car P64 from TFL Ledertechnik, Basel

10.00 g water

01.20 g Expancel 091 DE hollow microspheres from Akzo Nobel

The coating is applied with a doctor blade three times with a layer thickness of 100 μm and dried in a laboratory furnace after each layer.

The black leather so coated is placed in the laboratory furnace, together with a coated piece of leather of the same type, tinted in the standard fashion, and heated to 80° C. The leather pieces are removed from the furnace, and the heat flux from the leather sample into a 1 kg piece of lead at room temperature is measured. A universal heat flux sensor F-035-2, measuring 25×25 mm, from the Wuntronic company, Munich, is used. FIG. 1 shows the heat flux of the leather with the standard finishing (1; comparison) and curve (2) shows the heat flux, lower by about 500 W/m², of the leather sample coated according to the invention. This difference is also clearly detectable when a hand is placed on the leather samples.

The spectral reflection of the samples is measured in the wavelength range 400 to 980 nm (measurement instrument: PC-plug-in spectrometer, PC 2000, from The Avantes company, with a spectral sensitivity from 320 to 1,100 nm, with an Ulbricht sphere connected to it to measure hemispherical backscatter of surfaces); the measurement results are shown in FIG. 2:

Curve (1) shows the clearly higher reflection in the near infrared range of the black leather coated according to the invention. Reflection of the standard reference leather (2) lies below 10% also in the near infrared range. Both black leather samples are placed on a Styrofoam plate and exposed to about 800 W/m² strong solar radiation. The surface temperature of the standard leather rose to 90° C., and that of the leather according to the invention, on the other hand, only to 62° C. The density of the coated leather according to the invention lies at 0.85 g/cm² and the heat conductivity at 0.12 W/mK. The density of the standard coated leather lies at 1.1 g/cm³ and the heat conductivity at 0.15 W/mK. The density of the coated leather according to the invention is therefore 23%, and the heat conductivity 20% less than in the standard leather coated according to the prior art.

### Example 2

Reduction of Density and Heat Conductivity of a Leather:

A leather sample is placed in a water bath. 20 wt. % (referred to the weight of the leather) of unexpanded hollow microspheres of the Expancel 820SL80 type from Akzo Nobel are added to the water bath and incorporated in the leather by the usual process in a tannery. The leather is then tinted black with the dye Sella Cool Black 10286 from TFL Ledertechnik, Basel. The leather is placed into a furnace at about 100° C., until the hollow microspheres expand under the influence of heat and fill up part of the cavities in the leather.

One piece of the leather so produced according to the invention is placed onto a heating plate at 54° C., and heat transfer from the heat plate through the leather into a 1 kg water beaker with a water temperature of 7.5° C. is measured with the heat flux sensor F-035-2. The same procedure is carried out with a black standard leather (comparison).

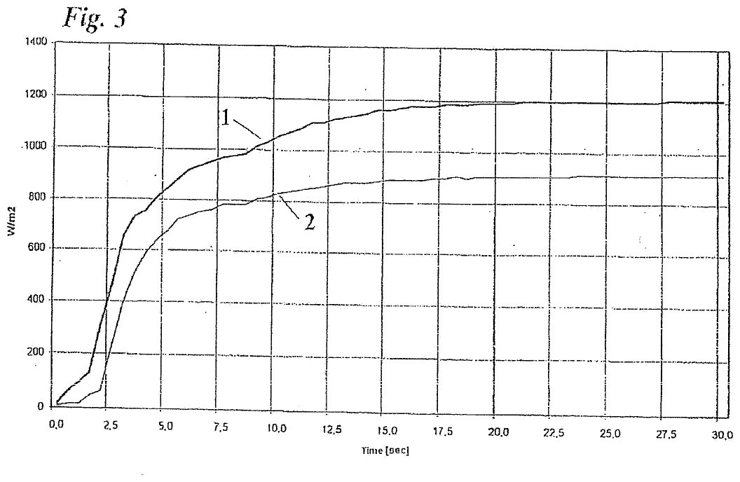

The time trend of heat flux through the leather samples is shown in FIG. 3 in W/m². Here, curve (1) shows the heat flux through the standard leather (comparison). The heat flux through the black leather sample (2) produced according to the invention is then about 200 W/m² lower. The density of the leather processed according to the invention lies at 0.85 g/cm³, and the heat conductivity at 0.1 W/mK. The density of the standard produced leather lies at 1.1 g/cm³ and the heat conductivity at 0.14 W/mK. The density of the leather processed according to the invention is therefore 23% lower, and the heat conductivity is 28% lower than in the comparison leather produced in standard fashion.

### Example 3

Combination of a Leather Sample Produced According to Example 2 with a Coating Produced According to Example 1:

A coating according to example 1 is applied three times with 100 μm layer thickness to a leather produced according to example 2, and dried. The leather according to the invention is placed on a heating plate at 58° C., and the heat transfer from the heating plate through the leather into a 1 kg water beaker with a water temperature of 0° C. (ice water) is measured with the heat flux sensor F-035-2. The same procedure is carried out with a black, coated standard leather (comparison).

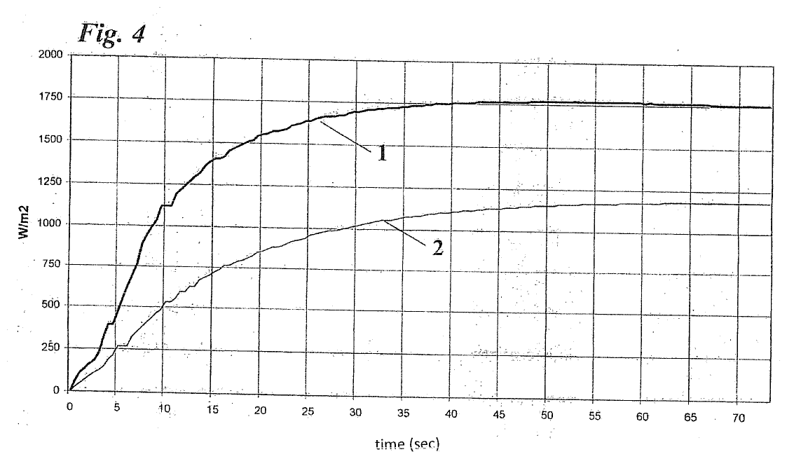

FIG. 4 shows the curve (1) of heat flux through the black standard leather (comparison). The heat flux through the leather (2) produced according to the invention is clearly lower.

The spectral reflection of the two black leather samples is measured as described in example 1, and is identical to the curves in FIG. 2. Curve (1) in FIG. 2 shows the spectral reflection of the leather produced according to the invention and curve (2) that of the standard leather (comparison). The density of the combination of leather and coating according to the invention lies at 0.82 g/cm³ and the heat conductivity at 0.09 W/mK. The density of the leather produced in standard fashion lies at 1.1 g/cm³ and the heat conductivity at 0.15 W/mK. The density of the combination according to the invention is therefore 25% lower, and the heat conductivity is 40% lower than in, the comparison leather produced in the standard fashion.

### Example 4

Polypropylene Component with Low Heat Conductivity and High Solar Reflection:

Two samples for interior fittings of a car, based on polypropylene, are produced according to the following formulation:

a.) 600.00 g polypropylene granulate
040.00 g SilCell 300 light filler from Chemco
050.00 g Hombitan R610K, titanium dioxide from Sachtleben
010.00 g Aerosil TT600 from Degussa
020.00 g Hostaperm Blue R5R from Clariant
010.00 g Paliogen Black L0086 from BASF

Dark blue sample plates were produced with a laboratory extruder.

b.) 600.00 g polypropylene granulate
030.00 g Hombitan R610K, titanium dioxide from Sachtleben
010.00 g Aerosil T600 from Degussa
020.00 g Hostaperm Blue R5R from Clariant
010.00 g Paliogen Black L0086 from BASF

The mixture is foamed in an extruder with carbon dioxide gas. Dark blue sample plates are produced. The density of the sample plate a) lies at 0.79 g/cm³, that of the sample plate b) at 0.74 g/cm³; the heat conductivity of the sample plate according to a) lies at 0.15 W/mK and that of sample plate b) at 0.13 W/mK. The density of the standard component (comparison) lies at 1.05 g/cm³ and the heat conductivity at 0.24 W/mK. The density of the sample plate a) therefore lies 25%, and the density of sample plate b) 29.5% below the density of the standard component. The heat conductivity of the sample plate a) lies 37%, and that of sample plate b) 46% below the heat conductivity of the standard component. The spectral reflection of sample plates a) and b), and a piece of a standard component in the same dark blue tint (comparison) is measured with the spectrometer described in example 1 in the wavelength range 400 to 980 nm.

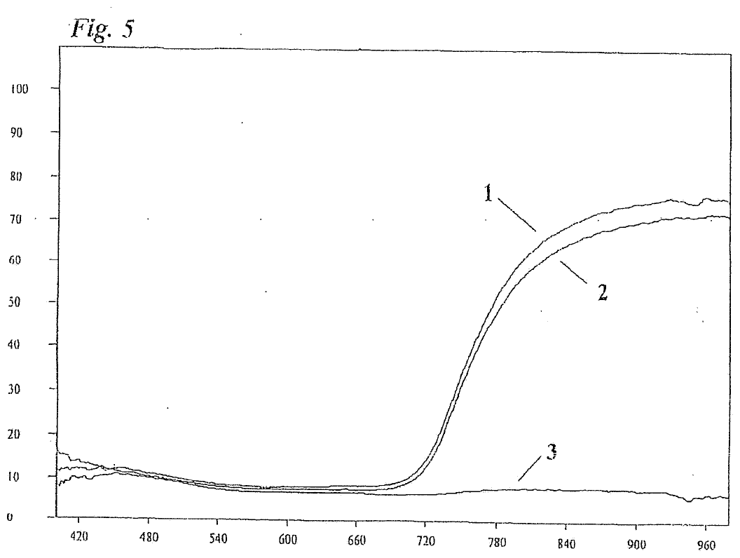

FIG. 5 shows the results of the measurement. Curve (1) shows the reflection of sample plate a), curve (2) that of the sample plate b), and curve (3) shows that the reflection of the standard component in the wavelength range of near infrared from 700 nm is only below 10%. The samples are placed on a Styrofoam plate and exposed to 800 W/m² solar radiation. Under these conditions, the surface temperature of the standard plate rises to 85° C., the surface temperature of the sample plates according to the invention lies at 60° C.

### Example 5

Production of a Sample Plate from Epoxy Resin According to the Invention and Comparative Example

A dark anthracite-colored sample plate of epoxy resin is produced according to the following formulation (invention):

45.00 g epoxy resin L160 from MGS Kunstharzprodukte GmbH, Stuttgart

03.00 g light filler Silcell 300 from Chemco Chemieprodukte GmbH

01.00 g titanium dioxide Hombitan R610K from Sachtleben

02.00 g Paliogen Black L0086, BASF

15.00 g H160 curing agent from MGS Kunstharzprodukte GmbH, Stuttgart

The sample plate had a density of 0.8 g/cm³ and the heat conductivity was 0.2 W/mK.

A dark anthracite-colored epoxy resin plate with standard pigmentation according to the following formulation was prepared as a comparative example:

45.00 g epoxy resin L160 from MGS Kunstharzprodukte GmbH, Stuttgart

05.00 g commercial black iron oxide

10.00 g talc from Wema, Nürnberg

00.50 g titanium dioxide Hombitan R610K from Sachtleben

15.00 g H160 curing agent from MGS Kunstharzprodukte GmbH, Stuttgart

The density of the standard plate was at 1.3 g/cm³ and the heat conductivity 0.3 W/mK. The density of the plate according to the invention is therefore 38% lower, and the heat conductivity is 33% lower than in the standard reference plate.

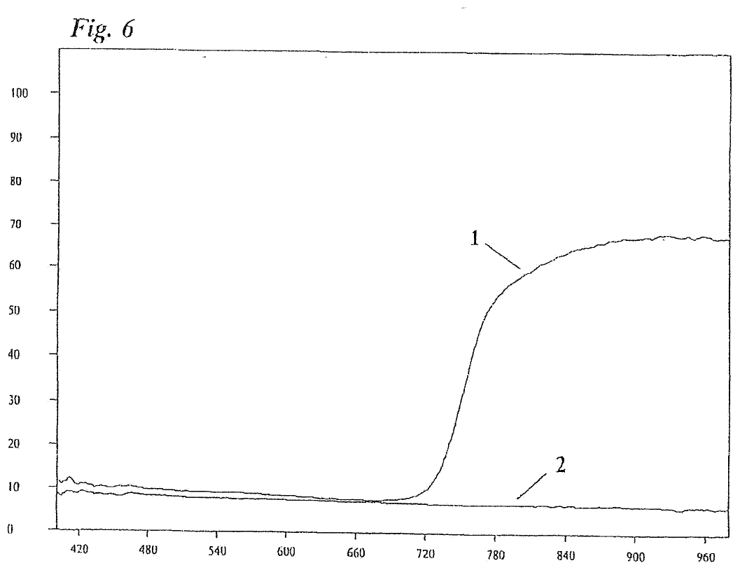

The spectral reflection of the two sample plates is measured with the spectrometer described example 1 in the wavelength range 400 to 980 nm. Curve (1) in the diagram of FIG. 6 shows the spectral reflection of the epoxide sample plate according to the invention and curve (2) the reflection of the sample plate of a comparative example. The reflection of the sample plate according to the invention is clearly higher in the near infrared range from 700 nm, which means that it absorbs less sunlight than the counter-example sample plate that is identically colored in the visible range. The samples were placed on a Styrofoam plate and exposed to 800 W/m² solar radiation. Under these conditions, the temperature of the plate according to the invention rises to only 60° C. and that of the comparative example to 85° C.

### Example 6

Preparation of a Film According to the Invention from Soft PVC and Comparative Example

A black film of soft PVC is prepared according to the following formula:

200.00 g commercial PVC with plasticizer

012.00 g light filler SilCell 300 from Chemco Chemieprodukte GmbH

003.50 g titanium dioxide Hombitan R610K from Sachtleben

007.50 g Paliogen Black L0086, BASF

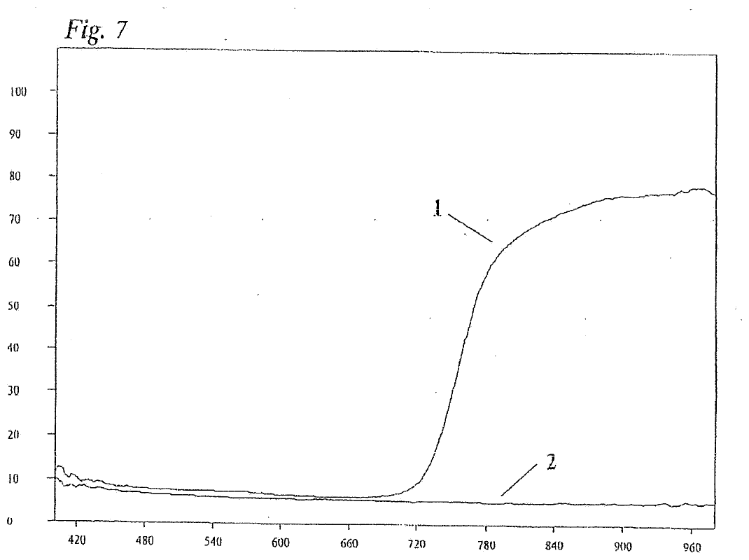

The density of the PVC film according to the invention is 0.95 g/cm³ and the heat conductivity 0.12 W/mK. The density of the commercial comparison film is 1.3 g/cm³ and the heat conductivity 0.18 w/mK. The density of the PVC film according to the invention is therefore 27% lower, and the heat conductivity is 33% lower than in the commercial comparison film. The spectral reflection of the PVC film is measured with the spectrometer described in example 1 in the wavelength range 400 to 980 nm. A commercial black film of soft PVC serves as comparative example. The measurement results are shown in FIG. 7. Curve (1) shows the increased reflection in the near infrared range of the film produced according to the invention, and curve (2) shows the reflection of the commercial black film. The samples are placed on a Styrofoam plate and exposed to 800 W/m² solar radiation. Under these conditions, the temperature of the commercial film rises to 90° C., that of the film according to the invention, however, only to 60° C.

### Example 7

Preparation of a Textile Coated on Both Sides for Blinds

A base textile for the curtain series Plaza™ Plus from Hunter Douglas Australia is coated on one side according to the following formulation:

Base Coat:

70.00 g binder Acronal 18D from BASF

15.00 g pigment preparation Hostatint White, the Hoechst company

05.00 g light filler Expancel 551WE20

After drying, an anthracite-colored cover coat is applied to this base coat in the tint of ebony from Plaza™ Plus of Hunter Douglas.

Cover Coat:

10.00 g water

10.00 g pigment preparation Roda Cool Black, TFL Ledertechnik company

40.00 g binder Acronal 18D from BASF

05.00 g water

01.00 g Hostatint White, the Hoechst company

The back side of the textile was coated twice with the white base coat.

The density of the textile according to the invention is 1.1 g/cm³ and the heat conductivity 0.15 W/mK. The density of the commercial counter-example is 1.3 g/cm³ and the heat conductivity 0.22 W/mK.

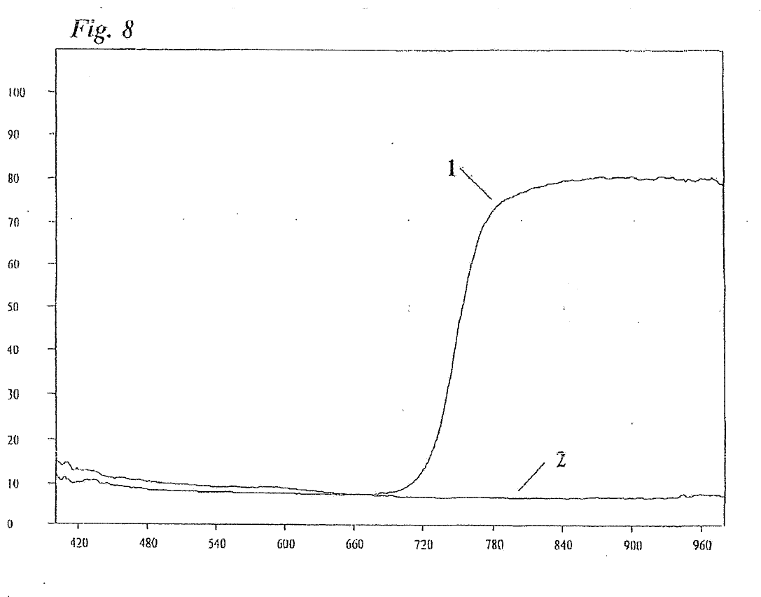

The density of the textile according to the invention is therefore 15% lower, and the heat conductivity is 32% lower than in the commercial counter-example. The spectral reflection of the anthracite-coated front side of the textile is measured with the spectrometer described in example 1 in the wavelength range 400 to 980 nm. Curve (1) in FIG. 8 shows the spectral reflection of the textile produced according to the invention, and curve (2) the reflection of the original curtain material ebony from the curtain series Plaza™ Plus from Hunter Douglas, Australia. The reflection here is below 10% as in the visible range. The samples were placed on a Styrofoam plate and exposed to 900 W/m² solar radiation. Under these conditions, the front side of the comparison curtain material is heated to 90° C.; that of the invention, on the other hand, only to 52° C. During use of the material according to the invention as blinds, the heat flux through the curtain into a space is 30% lower than in the comparison material under the following conditions:

Solar radiation 900 W/m²

Outside temperature 25° C.

Room temperature 21° C.

### Example 8

Preparation of a Sample Plate for PVC Window Profiles with Dark Surface

20 wt. % hollow microspheres of the type S38HS from the 3M Company, are added to a commercial white-tinted PVC granulate for the production of window profiles. A sample plate of 5 mm thickness is prepared in a laboratory extruder. Furthermore, 3 wt. %, relative to the amount of PVC granulate, Hostaperm Blue R5R from the Clariant company and 1.5 wt. % Paliogen Black L0086 from the BASF company are added to a commercial clear PVC granulate for production of PVC film, and melted and mixed in a laboratory extruder. A dark blue film of 300 μm thickness is produced. The film is glued with a clear hot-melt adhesive to the white PVC plate under pressure.

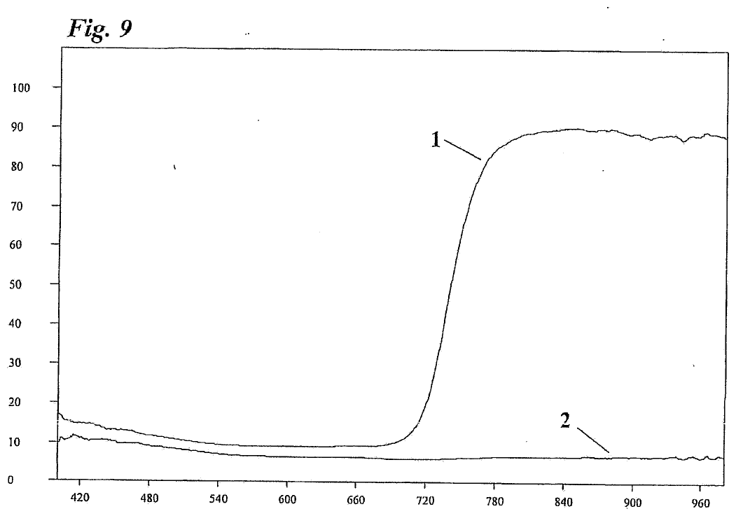

The density of the dark blue test sample for the window profile (invention) lies at 1.18 g/cm³ and the heat conductivity 0.14 W/mK. The density of a commercial PVC window profile (comparison) lies at 1.60 g/cm³ and the heat conductivity at 0.2 W/mK. The density of the comparison example according to the invention is therefore 26% lower, and the heat conductivity is 30% lower than in the commercial comparison profile. The spectral reflection of the plate is measured with the spectrometer described in example 1 in the wavelength range 400 to 980 nm, and compared with a commercial part of a dark blue-colored window profile. The measurement results are shown in FIG. 9. Curve (1) shows the distinctly higher reflection in the near infrared of the sample of a PVC window profile produced according to the invention. In the commercial dark blue part of the PVC window profile, the reflection in the near IR remains below 10%. The plates were exposed to 900 W/m² sunlight. The surface of the commercial plate reached a temperature of 90° C. and deformed slightly. The surface temperature of the plate according to the invention was only 60° C. and no deformation could be found. With use of the PVC window profile according to the invention under the following conditions:

Solar radiation 900 W/m²

Outside temperature 25° C.

Room temperature 21° C.,

the heat flux through the window frame into a room is 35% lower than in the standard material.

### Example 9

Preparation of a Brown-Colored Concrete Roofing Tile with Low Heat Conductivity

A sample plate of a concrete roofing tile is prepared according to the following formulation (invention):

35.00 g Portland cement from the Lugato company

05.00 g titanium dioxide Rutil Hombitan R210 from the Sachtleben company

10.00 g light filler SilCell 300 from the Chemco company

Water is added to the mixture, until a flowable consistency is achieved, whereupon the mixture is introduced to a mold and dried in a furnace. The dry concrete roofing tile is provided with a dark reddish-brown coating of the following formula:

140.00 g Acronal 18D from the BASF company

010.00 g Langdopec Red 30000 from the SLMC company

010.00 g Ferro PK 4047 Green from the Ferro company

007.50 g Sylowhite SM 405 from the Grace company

000.60 g defoamer Byk 024 from the Byk company

000.60 g pigment distributor N from the BASF company

000.40 g thickener Acrysol T 615 from the Rohm and Haas company

015.00 g water

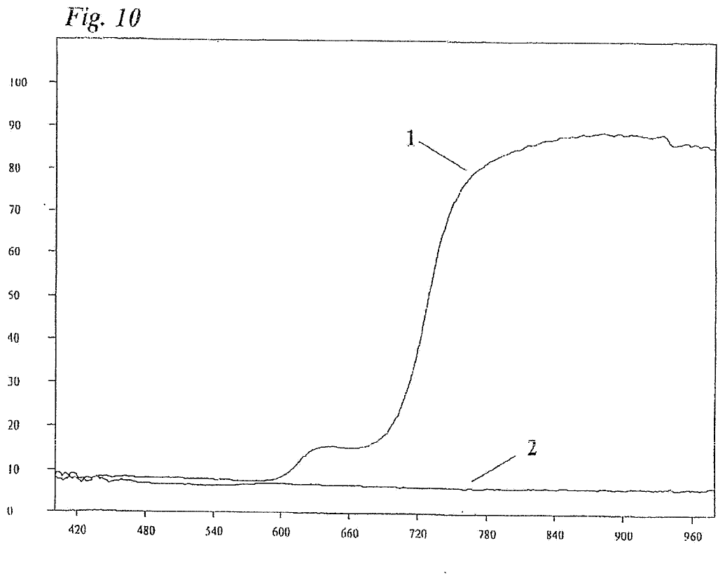

The spectral reflection of the dark reddish-brown concrete roofing title is measured with the spectrometer described in example 1 in the wavelength range 400 to 980 nm. As comparative example, a commercial concrete roofing tile in the tint dark brown C021 from the Kubota company in Japan is used. The measurement results are shown in FIG. 10. Curve (1) shows the distinct increase in reflection in the near infrared of the concrete roofing tile produced according to the invention, and curve (2) shows that the reflection of the commercial concrete roofing tile in the near infrared is even somewhat lower than in the visible wavelength range.

During heating of the roofing tiles and 850 W/m² sunlight, the surface of the commercial roofing tiles heated to 87° C. and that of the tile according to the invention only to 51° C. The density of the roofing tile according to the invention is 0.7 g/cm³′ and the heat conductivity 0.16 W/mK. The density of the commercial roofing tile was 1.6 g/cm³, and the heat conductivity 0.87 W/mK. The density of the roofing tile according to the invention is therefore 56% lower, and heat conductivity is 82% lower than in the commercial concrete roofing tile.

With use of the concrete roofing tile according to the invention under the following conditions:

Solar radiation 850 W/m²

Outside temperature 25° C.

Room temperature 21° C.,

the heat flow through a roof into the roof space is 45% lower than with the standard material.

### Example 10

Combination of an External Plaster with a Solar-Reflecting Exterior Wall Paint

A 2 cm thick plate, produced form an exterior plaster from the Colfirmit Rajasil company with the name “Ultralight plaster”, is coated with a light green exterior wall paint according to the following formulation.

200.00 g Acrylor FS White from the Relius Coatings company

010.00 g pigment preparation Roda Cool Black from the TFL Ledertechnik company

For comparison, an exterior wall paint from the Sonneborn company USA in the tint Drumhill Grey 458-M is applied to a 2 cm thick plate of commercial plaster.

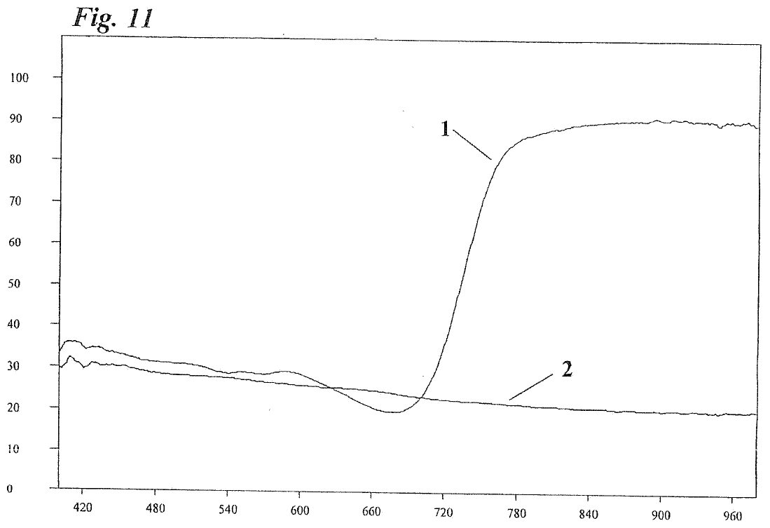

The spectral reflection of both plaster plates is measured with the spectrometer described in example 1 in the wavelength range 400 to 980 nm. The measurement results are shown in FIG. 11. Curve (1) shows that the reflection of the combination of an exterior plaster with a solar-reflecting exterior wall paint produced according to the invention is higher in the near infrared range than the reflection in the near IR of the plaster plate coated in the standard manner, shown by curve (2).

The total density of the combination according to the invention is 0.9 g/cm³. The total density of the standard combination is 2.2 g/cm³. The heat conductivity of the combination according to the invention of a light plaster with a solar-reflecting paint is 0.12 W/mK, that of the standard combination 0.87 W/mK. The total density of the combination according to the invention is therefore 59% lower, and the heat conductivity is 86% lower than in the standard combination.

When the combination according to the invention is used on a 20 cm thick concrete wall under the following conditions:

Solar radiation 800 W/m²

Outside temperature 25° C.

Room temperature 21° C.,

the heat flux through the wall into the house is 42% lower than in the standard material.

1-32. (canceled)

33: A film with low heat conductivity, reduced density and low solar absorption, the film comprising:
at least one combination of a plastic support material and components incorporated into the plastic support material, the components incorporated into the plastic support material consisting of:
a) and/or b);
and at least one of c), d), and e); and
optionally f), wherein:
a) comprises inorganic and/or organic light fillers, which reduce the density and heat conductivity of the plastic support material;
b) comprises gases selected from the group consisting of air, nitrogen, carbon dioxide, and noble gases, which form cavities in the plastic support material and reduce the density and heat conductivity of the plastic support material;
c) comprises dyes, which reflect with spectral selectivity in the wavelength range of visible light from 400 to 700 nm and have an average transparency of greater than 50% in the wavelength range of the near infrared from 700 to 1,000 nm;
d) comprises first pigments, which reflect with spectral selectivity in the wavelength range of visible light from 400 to 700 nm and have an average transparency of greater than 50% in the wavelength range from 700 to 1,000 nm;
e) comprises second pigments, which reflect with spectral selectivity in the wavelength range of visible light from 400 to 700 nm and have an average reflection of greater than 50% in the wavelength range of the near infrared from 700 to 1,000 nm; and
f) comprises inorganic and/or organic nanomaterials, which can be surface-treated or surface coated, and
wherein the at least one combination has the following properties:
i) an average reflection in the wavelength range of visible light from 400 to 700 nm less than 50%;
ii) an average reflection in the wavelength range of near infrared from 700 to 1,000 nm greater than 50%;
iii) a heat conductivity less than 0.4 (W/m·K); and
iv) a bulk density that lies below 1.4 g/cm³.

34: The film according to claim 33, wherein the plastic support material is selected from the group consisting of polyamides, polyacetates, polyesters, polycarbonates, polyolefins, styrene polymers, sulfur polymers, fluorinated plastics, polyimides, polymethylmethacrylates (PMMA), polyvinyl chloride, silicones, epoxy resins, polymer blends, polycarbonate-ABS, melamine resins, phenolic resins, polyurethanes, and mixtures thereof.

35: The film according to claim 33, wherein the plastic support material is both a reactively crosslinking plastic and a thermoplastic.

36: The film according to claim 33, wherein the density of the light fillers is less than 0.5 g/cm³.

37: The film according to claim 33, wherein the light fillers comprise hollow microspheres made from material selected from the group consisting of ceramic having a density less than 0.4 g/cm³, glass having a density less than 0.4 g/cm³, and plastic having a density less than 0.2 g/cm³.

38: The film according to claim 33, wherein the light fillers are plastic particles that only form hollow microspheres with a density below 0.2 g/cm³ when the plastic support material is heated to temperatures of 80 to 160° C.

39: The film according to claim 33, wherein the dyes are selected from the group consisting of acid dyes, direct dyes, basic dyes, development dyes, sulfur dyes, aniline dyes, and zapon dyes.

40: The film according to claim 33, wherein the first pigments are selected from the group consisting of monoazo, disazo, α-naphthol, naphthol-AS, laked azo, benzimidazolone, disazocondensation, metal complex, isoindolinone, isoindoline phthalocyanine, quinacridone, perylene and perinone, thioindigo, anthraquinone, anthrapyrimidine, flavanthrone, pyranthrone, indanthrone, anthanthrone, dioxazine, triarylcarbonium, quinophthalone, and diketo pyrrolo pyrrole pigments.

41: The film according to claim 33, wherein the second pigments are inorganic pigments selected from the group consisting of metal oxides, metal hydroxides, cadmium pigments, bismuth pigments, chromium pigments, ultramarine pigments, coated mica pigments in the form of platelets, and rutile and spinel mixed phase pigments.

42: The film according to claim 33, wherein additional particles are incorporated in the plastic support material, the additional particles having a reflection greater than 70% in the wavelength range from 400 to 1,000 nm.

43: The film according to claim 42, wherein the additional particles of inorganic pigments are selected from the group consisting of metal oxides, metal sulfates, metal sulfides, metal fluorides, metal silicates, metal carbonates, and mixtures thereof.

44: The film according to claim 42, wherein the additional particles are degradable materials selected from the group consisting of calcium carbonate, magnesium carbonate, talc, zirconium silicate, zirconium oxide, aluminum oxide, natural barium sulfate, and mixtures thereof.

45: The film according to claim 33, wherein the element's heat conductivity is less than 0.3 (W/m·K).

46: The film according to claim 33, wherein the bulk density of the element is less than 1.2 g/cm³.

47: The film according to claim 33, wherein it has an average reflection of less than 40% in the wavelength range of visible light from 400 to 700 nm.

48: The film according to claim 33, wherein it has an average reflection of greater than 60% in the wavelength range of near infrared from 700 to 1,000 nm.

49: The film according to claim 33, wherein the light fillers increase the reflection of the element by up to 10% in the near infrared range from 700 to 1,000 nm.

50: The film according to claim 33, wherein the element has at least one layer consisting of the combination.

51: The film according to claim 33, wherein the element further includes a layer that is combined with another layer of the plastic support material that does not contain the incorporated components.

52: The film according to claim 33, wherein identical or different variants of the element are combined in at least two layers.

53: The film according to claim 33, further comprising a lacquer coating.

54: The film according to claim 33, wherein the plastic support material further comprises a device or layer.
